(19) United States
(12) Patent Application Publication
(10) Pub. No.: US 2026/0360934 A1
(43) Pub. Date: Nov. 12, 2026

(54) Busbar and Battery Module Including the Same

(71) Applicant: LG Energy Solution, Ltd., Seoul (KR)

(72) Inventors: Sangwoo Han, Daejeon (KR); Seungho Jeon, Daejeon (KR); Jinhwan Shin, Daejeon (KR); Kwangseok Yun, Daejeon (KR); Hyungkeun Park, Daejeon (KR); Minkeun Keum, Daejeon (KR); Yong Shik Shin, Daejeon (KR); Jiyong Kim, Daejeon (KR); Jaein Bae, Daejeon (KR)

(73) Assignee: LG Energy Solution, Ltd., Seoul (KR)

(21) Appl. No.: 19/489,767

(22) PCT Filed: Nov. 11, 2024
(86) PCT No.: PCT/KR2024/017780

§ 371 Date: Dec. 3, 2025

(30) Foreign Application Priority Data
Dec. 22, 2023 (KR) 10-2023-0190382
Nov. 5, 2024 (KR) 10-2024-0155190

(51) Int. Cl. H01M 50/507; H01M 50/211; H01M 50/242; H01M 50/516; H01M 50/522

(52) U.S. Cl. CPC H01M 50/507; H01M 50/211; H01M 50/242; H01M 50/516; H01M 50/522

(57) ABSTRACT

A busbar including a first conductive layer made of a first metal and having a first side edge, a second side edge opposite the first side edge, and a first surface extending between the first and second side edges; and a second conductive layer made of a second metal that is different from the first metal and that is laminated on and bonded to the first surface of the first conductive layer is provided. The first conductive layer has an exposed area where the first metal is exposed on the first surface of the first conductive layer to which the second conductive layer is bonded, and the second conductive layer extends from the first side edge toward the second side edge of the first conductive layer, without covering the exposed area of the first conductive layer.

### TECHNICAL FIELD

The present disclosure relates to a busbar and a battery module including the same, and more specifically, to a busbar formed by bonding dissimilar metals and a battery module including the same.

### BACKGROUND ART

A secondary battery refers to a battery that can be charged and discharged, unlike a primary battery that cannot be charged, and is applied not only to portable devices but also to electric vehicles (EVs) and hybrid electric vehicles (HEVs) that are driven using an electric drive source.

Currently widely used types of secondary batteries include lithium ion batteries, lithium polymer batteries, nickel cadmium batteries, nickel hydrogen batteries, nickel zinc batteries, etc. The operating voltage of such a unit secondary battery cell, i.e., a unit battery cell, is approximately 2.5 V to 4.6 V. Therefore, when a higher output voltage is required, a battery pack is configured by connecting multiple battery cells in series. In addition, a battery pack is configured by connecting multiple battery cells in parallel depending on the charge/discharge capacity required for the battery pack. Therefore, the number of battery cells included in the battery pack can be set in various ways depending on the required output voltage or charge/discharge capacity.

When a battery pack is configured by connecting multiple battery cells in series/parallel, it is common to first configure a battery module composed of at least one battery cell, preferably multiple battery cells, and then use at least one battery module and add other components to configure the battery pack. Here, the battery module refers to a component in which multiple battery cells are connected in series or parallel, and the battery pack may refer to a component in which multiple battery modules are connected in series or parallel to increase capacity and output.

The battery module is configured by electrically connecting multiple cells using a busbar, and electrode leads of the battery cells are connected to the busbar.

However, when the electrode leads of the battery cells are connected to the busbar, the electrode leads made of a metal different from the busbar may be bonded to the busbar, causing corrosion at the welding surface, increasing the crack occurrence rate, and reducing weldability.

### DETAILED DESCRIPTION OF INVENTION

### Technical Problems

An object of the present disclosure devised to solve the problems described above is to provide a busbar with improved weldability and a battery module including the same.

### Technical Solution

A busbar according to an embodiment of the present disclosure includes: a first conductive layer having a first side edge, a second side edge opposite the first side edge, and a first surface extending between the first and second side edges, and made of a first metal; and a second conductive layer made of a second metal different from the first metal and laminated on and bonded to the first surface of the first conductive layer, wherein the first conductive layer has an exposed area where the first metal is exposed on the first surface of the first conductive layer to which the second conductive layer is bonded, and the second conductive layer extends from the first side edge toward the second side edge of the first conductive layer, leaving the exposed area of the first conductive layer.

Furthermore, the second conductive layer may extend from the first side edge to the second side edge.

Furthermore, the exposed area of the first conductor layer may extend from the second side edge toward the first side edge.

Furthermore, the first metal or the second metal may include aluminum.

Furthermore, the first metal or the second metal may include copper.

Furthermore, the first conductor layer may have a through hole.

Furthermore, the through hole may be disposed between the exposed area and the second conductor layer.

Furthermore, the second conductor layer may include a first portion, a second portion extending from one end of the first portion toward the second side edge of the first conductor layer, and a third portion extending from the other end of the first portion toward the second side edge of the first conductor layer.

Furthermore, the first portion of the second conductor layer may be disposed parallel to the exposed area of the first conductor layer.

Furthermore, the first conductor layer may have a through hole, and the through hole may be disposed between the first portion of the second conductor layer and the exposed area of the first conductor layer.

A battery module according to an embodiment of the present disclosure includes: a battery cell stack in which a plurality of battery cells is stacked; a module case for accommodating the battery cell stack; and a busbar for electrically connecting the battery cell, wherein the busbar includes: a first conductor layer having a first side edge, a second side edge opposite the first side edge, and a first surface extending between the first and second side edges, and made of a first metal; and a second conductive layer made of a second metal different from the first metal, and laminated on and bonded to the first surface of the first conductive layer, wherein the first conductive layer has an exposed area where the first metal is exposed on the first surface of the first conductive layer to which the second conductive layer is bonded, and the second conductive layer extends from the first side edge toward the second side edge of the first conductive layer, leaving the exposed area of the first conductive layer.

Furthermore, electrode leads of the battery cells made of the first metal may be coupled to the exposed area of the first conductor layer, and electrode leads of the battery cells made of the second metal may be coupled to the second conductor layer.

Furthermore, the battery module may further include a terminal busbar made of the first metal, wherein the electrode leads of the battery cells made of the first metal may be coupled to the terminal busbar.

Furthermore, the battery module may further include a terminal busbar made of the second metal, wherein the electrode leads of the battery cells made of the second metal may be coupled to the terminal busbar.

Furthermore, the battery module may further include a busbar frame disposed on one side of the battery cell stack, and the busbar may be disposed in the busbar frame.

### Effect of Invention

The busbar and battery module according to an embodiment of the present disclosure have the effect of improving weldability by welding electrode leads and busbars made of the same type of metal.

### BRIEF DESCRIPTION OF THE DRAWING

FIG. 1 is a perspective view of a battery module according to an embodiment of the present disclosure.

FIG. 2 is an exploded perspective view of the battery module according to an embodiment of the present disclosure.

FIG. 3 is a perspective view of a battery cell according to an embodiment of the present disclosure.

FIG. 4 is a perspective view of a terminal busbar according to an embodiment of the present disclosure.

FIG. 5 is a perspective view of an insulating cover and an end plate according to an embodiment of the present disclosure.

FIG. 6 is a detailed view of a busbar frame according to an embodiment of the present disclosure.

FIG. 7 is a diagram showing a busbar to which an electrode lead is coupled in an embodiment of the present disclosure.

FIG. 8 is a diagram showing a busbar in an embodiment of the present disclosure.

FIG. 9 is an exploded perspective view of the busbar of FIG. 8.

FIG. 10 is a cross-sectional view taken along line A-A in FIG. 8.

FIG. 11 is a rear view of the busbar of FIG. 8.

FIG. 12 is a diagram showing a busbar according to another embodiment of the present disclosure.

FIG. 13 is a diagram showing a busbar (terminal busbar) weld plate in an embodiment of the present disclosure.

### BEST MODE FOR CARRYING OUT THE INVENTION

The advantages and features of the present disclosure, and the methods for achieving the same will become clear with reference to the embodiments described below in conjunction with the accompanying drawings. However, the present disclosure is not limited to the embodiments disclosed below, but may rather be implemented in various different forms, and these embodiments are provided only to make the present disclosure complete and to fully inform those skilled in the art of the scope of the disclosure, and the present disclosure is defined only by the scope of the claims. Accordingly, in some embodiments, well-known process steps, well-known device structures, and well-known techniques are not specifically described in order to avoid ambiguity in the interpretation of the present disclosure. Like reference numerals refer to like elements throughout the specification.

In the drawings, the thickness may be enlarged to clearly express various layers and regions. Like reference numerals are used for similar parts throughout the specification. When a part, such as a layer, a film, a region, or a plate, is said to be “on” another part, this includes not only cases where it is “directly on” the other part, but also cases where there is another part in between. Conversely, when a part is said to be “directly on” another part, it means that there is no other part in between. Further, when a part, such as a layer, a film, a region, or a plate, is said to be “beneath” another part, this includes not only cases where it is “directly beneath” the other part, but also cases where there are other parts in between. Conversely, when a part is said to be “directly beneath” another part, it means that there are no other parts in between.

A busbar and a battery module 1000 according to an embodiment of the present disclosure will be described in detail with reference to the drawings.

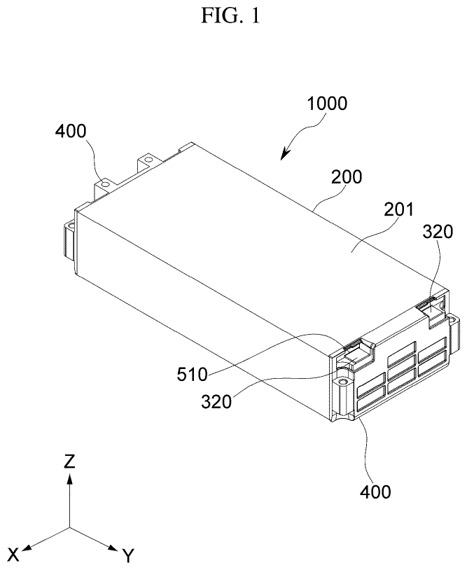

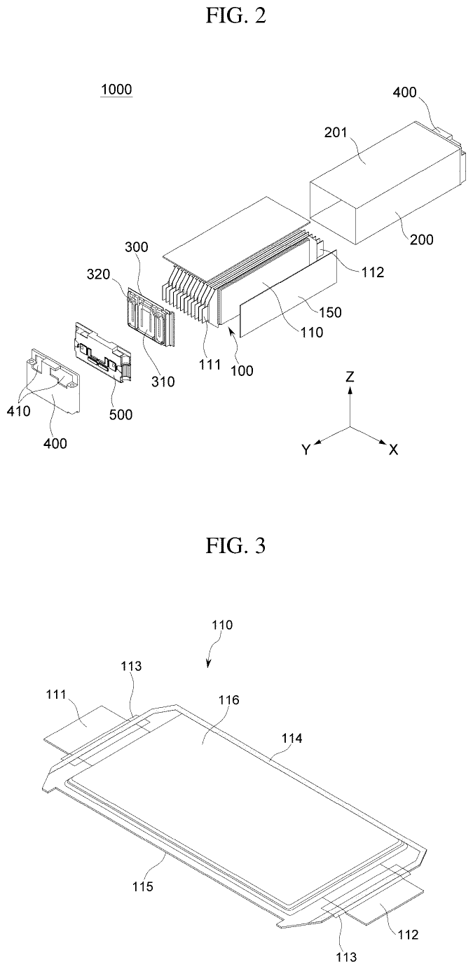

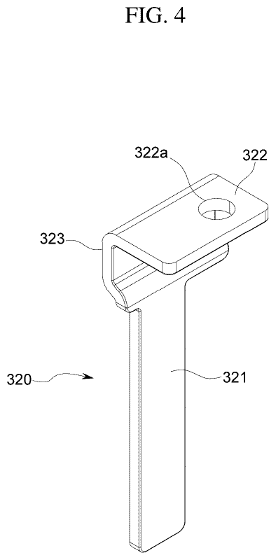

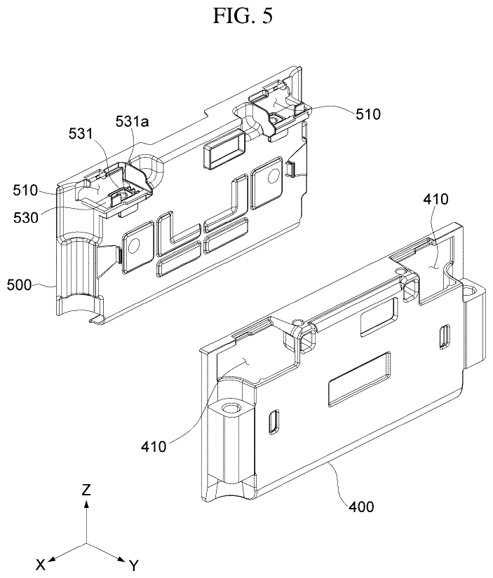

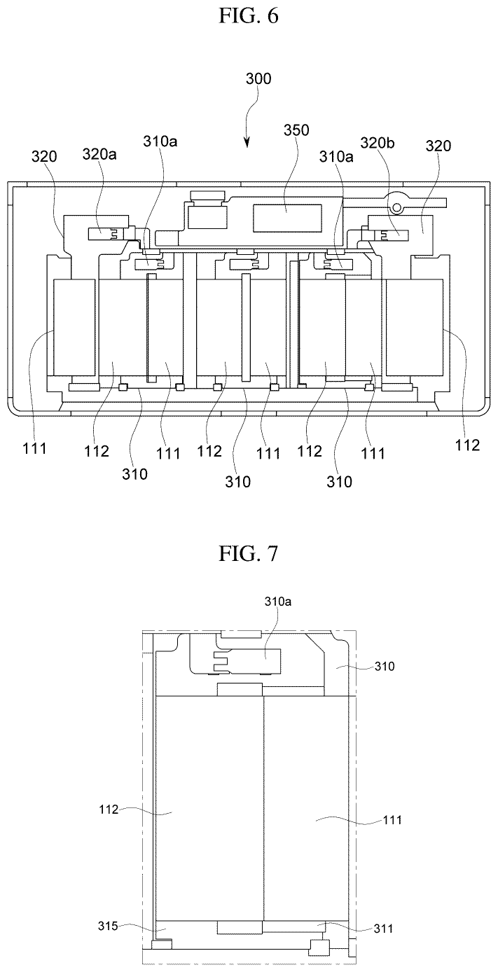

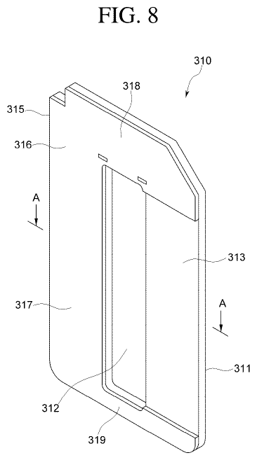

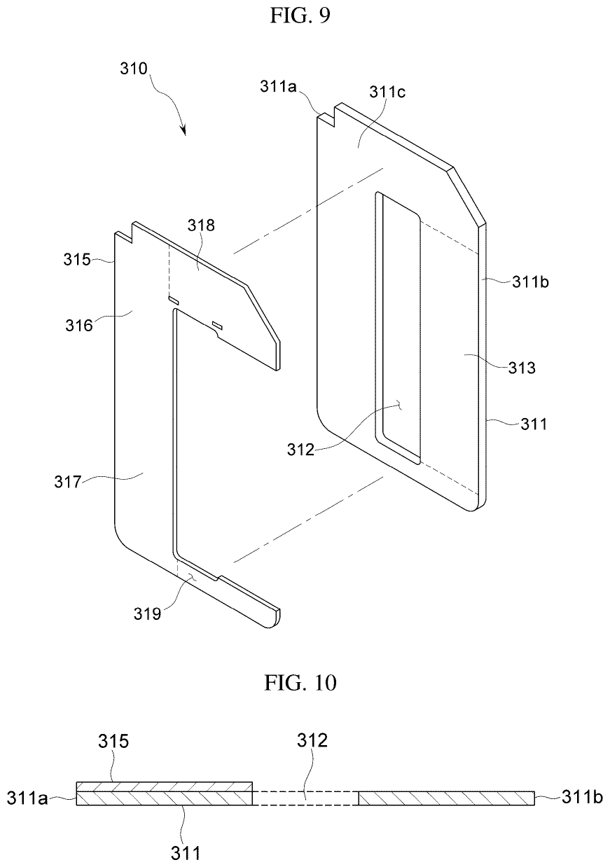

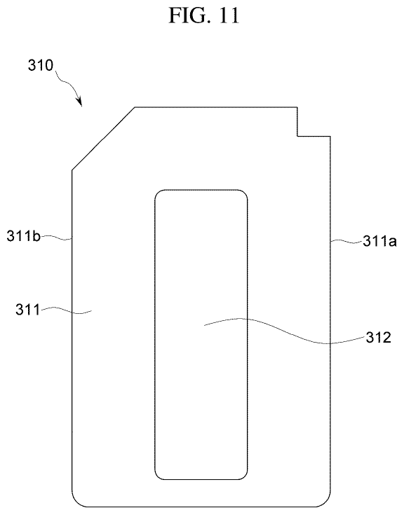

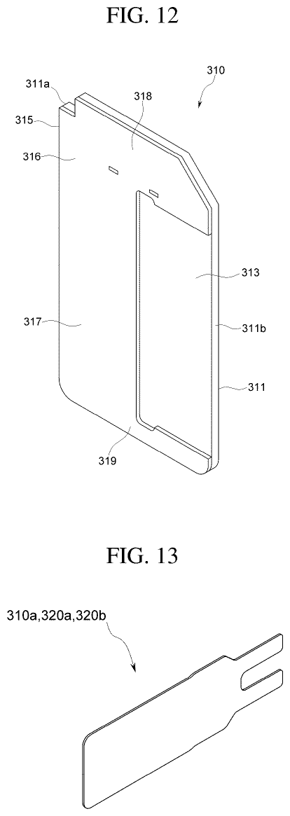

FIG. 1 is a perspective view of a battery module according to an embodiment of the present disclosure, FIG. 2 is an exploded perspective view of the battery module according to an embodiment of the present disclosure, FIG. 3 is a perspective view of a battery cell according to an embodiment of the present disclosure, FIG. 4 is a perspective view of a terminal busbar according to an embodiment of the present disclosure, FIG. 5 is a perspective view of an insulating cover and an end plate according to an embodiment of the present disclosure, FIG. 6 is a detailed view of a busbar frame according to an embodiment of the present disclosure, FIG. 7 is a diagram showing a busbar to which an electrode lead is coupled in an embodiment of the present disclosure, FIG. 8 is a diagram showing a busbar in an embodiment of the present disclosure, FIG. 9 is an exploded perspective view of the busbar of FIG. 8, FIG. 10 is a cross-sectional view taken along line A-A in FIG. 8, FIG. 11 is a rear view of the busbar of FIG. 8, FIG. 12 is a diagram showing a busbar according to another embodiment of the present disclosure, and FIG. 13 is a diagram showing a busbar (terminal busbar) weld plate in an embodiment of the present disclosure.

The battery module 1000 according to one embodiment of the present disclosure may include a battery cell stack 100 in which a plurality of battery cells 110 is stacked, a module case 200 that accommodates the battery cell stack 100, a busbar frame 300 positioned on one side and/or the other side of the battery cell stack 100, an insulating cover 500 positioned on the outside of the busbar frame 300, and an end plate 400 positioned on the outside of the insulating cover 500.

The battery cell stack 100 may be formed by stacking the plurality of battery cells 110 in one direction, and the plurality of battery cells 110 may be electrically connected. The direction in which the plurality of battery cells 110 is stacked may be the X-axis direction (or −X-axis direction) in FIG. 2.

The direction from the front to the rear of the battery cell stack 100 or the opposite direction may be defined as the longitudinal direction of the battery cell stack 100 and may be the Y-axis direction in the figure. In addition, the direction from the upper surface to the lower surface of the battery cell stack 100 or the opposite direction may be defined as the width direction of the battery cell stack 100 and may be the Z-axis direction in the figure.

The longitudinal direction of the battery cell stack 100 may be substantially the same as the longitudinal direction of the battery cells 110. Electrode leads 111 and 112 of the battery cells 110 may be positioned on the front and rear sides of the battery cell stack 100, and busbars 310 and 320 of the battery module 1000 may be positioned close to the front and rear sides of the battery cell stack 100 to easily form electrical connections with the electrode leads 111 and 112.

The battery cell 110 may be provided as a pouch-type battery cell, and the number of battery cells stacked per unit area may be maximized in the case of the pouch-type battery cell. However, the battery cell 110 does not necessarily have to be provided in a pouch type, and may be provided in a square, cylindrical, or other various shapes.

The battery cell 110 provided in a pouch type may include an electrode assembly and a cell case 115 that accommodates the electrode assembly (refer to FIG. 3).

The cell case 115 of the battery cell 110 may be a pouch-type cell case 115 for accommodating the electrode assembly. The cell case 115 includes a lower case and an upper case that covers the lower case, and the upper and lower cases may be formed as one piece. In addition, as illustrated in FIG. 3, connecting portions of the upper and lower cases may be formed in a structure in which they are bent and folded. In addition, as illustrated, the upper case may completely cover the lower case, and a sealing portion 114 may be formed at the edge.

The upper and lower cases may both be formed in a laminate structure including an inner covering layer, a metal layer, and an outer covering layer. The inner covering layer is located on the inside of the cell case 115 based on the metal layer, and the inner covering layer needs to have insulation and electrolytic resistance since it is in direct contact with the electrode assembly, and in order to achieve sealing, a sealing area where the inner layers are thermally bonded is required to have excellent thermal bonding strength. The metal layer is located between the inner covering layer and the outer covering layer and corresponds to a barrier layer that prevents moisture or various gases from penetrating into the battery from the outside, and a preferable material for the metal layer in contact with the inner covering layer may be an aluminum (Al) thin film that is lightweight and has excellent formability. The outer covering layer is located on the outside of the cell case 115 based on the metal layer, and the outer covering layer can use a heat-resistant polymer that has excellent tensile strength, moisture permeability, and air permeability to protect the electrode assembly while ensuring heat resistance and chemical resistance, and for example, nylon or polyethylene terephthalate may be used for the outer covering layer.

A receiving groove 116 may be formed in the upper and lower cases, and the electrode assembly may be received in the receiving groove 116 of the upper and lower cases.

The electrode assembly accommodated in the cell case 115 may be one of a group consisting of a jelly-roll type electrode assembly having a structure in which a separator is interposed between long sheet-shaped positive and negative electrodes and then rolled up, a stack type electrode assembly composed of unit cells having a structure in which rectangular positive and negative electrodes are laminated with a separator interposed therebetween, a stack-folding type electrode assembly in which unit cells are rolled up by a long separator film, and a lamination-stack type electrode assembly in which unit cells are laminated with a separator interposed therebetween and attached to each other.

In addition, the electrode assembly may include two electrode tabs and two electrode leads 111 and 112 respectively connected to the electrode tabs by a welding part.

One of the two electrode leads 111 and 112 may be a positive lead connected to a positive tab, and the other electrode lead may be a negative lead connected to a negative tab. For example, the positive electrode lead 111 may be made of aluminum (Al), and the negative electrode lead 112 may be made of copper (Cu).

A lead film 113 may be attached to each of the electrode leads 111 and 112. The lead film 113 coupled to the electrode leads 111 and 112 is positioned between the electrode leads 111 and 112 and the cell case 115 to prevent a short circuit from occurring between the electrode leads 111 and 112 and the cell case 115 and to improve sealing power, thereby preventing leakage of the electrolyte, and the like.

The two electrode leads 111 and 112 are illustrated as being respectively positioned on both sides of the electrode assembly, but may be positioned on only one side of the electrode assembly depending on the arrangement of the electrode tabs.

The module case 200 may be for protecting the battery cell stack 100 and electrical components connected thereto from external physical impact, and the module case 200 may accommodate the battery cell stack 100 and the electrical components connected thereto in the internal space thereof.

The module case 200 may have various structures, and for example, the module case 200 may have a mono-frame structure. Here, a mono-frame may be in the form of a metal plate in which the upper surface, the lower surface, and both side surfaces are integrated. The mono-frame may be manufactured by extrusion molding. As another example, the module case 200 may have a structure in which a U-shaped frame and an upper plate (upper surface 201) are combined. In the case of a structure in which a U-shaped frame and an upper plate are combined, the structure of the module case 200 may be formed by combining the upper plate on the upper side of the U-shaped frame, which is a metal plate in which the lower side and both sides are combined or integrated, and each frame or plate may be manufactured by press molding. In addition, the module case 200 may have an L-shaped frame structure in addition to a mono-frame or a U-shaped frame, and may be provided as in various structures not described in the above-described examples.

The structure of the module case 200 may be provided in an open form in the longitudinal direction of the battery cell stack 100. The front and rear sides of the battery cell stack 100 may not be covered by the module case 200. The electrode leads 111 and 112 of the battery cells 110 may not be covered by the module case 200. The front and rear of the battery cell stack 100 may be covered by the busbar frame 300, the end plate 400, or the busbars 310 and 320 which will be described later, and accordingly, the front and rear of the battery cell stack 100 can be protected from external physical impacts and the like.

A compression pad 150 may be positioned between the battery cell stack 100 and one side of the inner surface of the module case 200.

The compression pad 150 may be disposed to face the battery cell 110 positioned at the outermost side of the battery cell stack 100 in the X-axis direction in the figure.

Further, although not shown, a thermally conductive resin may be injected between the battery cell stack 100 and the inner surface of the module case 200, and a thermally conductive resin layer (not shown) may be formed between the battery cell stack 100 and one side of the inner surface of the module case 200 by the injected thermally conductive resin. Here, the thermally conductive resin layer may be positioned on the Z-axis of the battery cell stack 100, and the thermally conductive resin layer may be formed between the battery cell stack 100 and the bottom surface positioned on the −Z-axis of the module case 200.

The busbar frame 300 may be positioned on one side of the battery cell stack 100 and may cover one side of the battery cell stack 100 while guiding connection between the battery cell stack 100 and an external device. Specifically, the busbar frame 300 may be positioned on the front or rear of the battery cell stack 100 as illustrated, or may also be positioned on the upper surface, lower surface, or side surface. At least one of the busbars 310 and 320 and a module connector may be mounted on the busbar frame 300. As illustrated in FIG. 2, one side of the busbar frame 300 may be connected to one side or the other side of the battery cell stack 100, and the other side of the busbar frame 300 may be connected to the busbars 310 and 320.

The busbar frame 300 may be made of an electrically insulating material or may include an insulating material. The busbar frame 300 may restrict the busbars 310 and 320 from contacting other portions of the battery cells 110 other than the portion where the busbars are connected to the electrode leads 111 and 112, and may prevent an electrical short circuit from occurring. The busbar frame 300 may be positioned on one side and the other side of the battery cell stack 100.

FIG. 6 is a diagram illustrating the busbar frame 300 according to an embodiment of the present disclosure. The busbars 310 and 320 may be mounted on one side of the busbar frame 300, and the busbars 310 and 320 may be for electrically connecting the battery cell stack 100 or the battery cells 110 and an external device circuit. A plurality of busbars 310 and 320 may be disposed. By positioning the busbars 310 and 320 between the battery cell stack 120 or the busbar frame 300 and the end plate 400, the busbars 310 and 320 may be protected from the external impact, and durability degradation due to external moisture may be minimized.

The busbars 310 and 320 may be electrically connected to the battery cell stack 100 through the electrode leads 111 and 112 of the battery cell 110.

Specifically, the electrode leads 111 and 112 of the battery cell 110 may be bent after passing through a lead slit formed in the busbar frame 300 and connected to the busbars 310 and 320.

The busbar 310 may be for electrically connecting the battery cells, and as shown in FIG. 6 and FIG. 7, the electrode leads 111 and 112 of the battery cells 110 may be connected to both sides of the busbar 310, the electrode lead 111 connected to one side of the busbars 310 and 320 may be a positive lead, and the electrode lead 112 connected to the other side of the busbars 310 and 320 may be a negative lead.

In the present embodiment, the busbar 310 may be a clad metal busbar formed by bonding different types of metals. As a clad metal busbar, the busbar 310 may be formed by bonding a first conductor layer 311 and a second conductor layer 315 as shown in FIG. 8 to FIG. 10, and may be formed by laminating the second conductor layer 315 on the first conductor layer 311. The busbar 310 may have a through hole 312. In addition, as another embodiment, the busbar 310 may not have the through hole 312. FIG. 12 is a diagram showing a busbar 310 without a through hole 312.

The first conductor layer 311 and the second conductor layer 315 may be laminated metal plates. The first conductor layer 311 may have an approximately square shape. The first conductor layer 311 may have a first side edge 311a and a second side edge 311b. The first side edge 311a and the second side edge 311b may be parallel and disposed on opposite sides.

In addition, the first conductor layer 311 may have a first surface 311c, and the second conductor layer may be laminated on the first surface 311c. The first surface 311c may extend between the first side edge 311a and the second side edge 311b and may be formed as a plane.

The first conductor layer 311 may be formed of a first metal, and the second conductor layer 315 may be formed of a second metal different from the first metal. The first metal may include aluminum (Al) or may be aluminum. The second metal may include copper (Cu) or may be copper. Alternatively, the second metal may include aluminum (Al) or may be aluminum. The first metal may include copper (Cu) or may be copper. Alternatively, the first metal or the second metal may be formed of an alloy of aluminum or copper and another metal.

The first conductive layer 311 may have the through hole 312 in the center as illustrated, and an exposed area 313 in which the first metal is exposed may be formed as an area where the second conductive layer 315 is not laminated on the first surface 311c of the first conductive layer 311. The exposed area 313 may extend from the second side edge 311b toward the first side edge 311a. The exposed area 313 may not extend to the first side edge 311a. The exposed area 313 may extend from the second side edge 311b to one edge of the through hole 312.

The positive electrode lead 111 made of the first metal (or aluminum) in the battery cell 110 may be bonded to the exposed area 313, and the positive electrode lead 111 may be electrically connected to the first conductor layer 311 by welding in the exposed area 313.

The second conductor layer 315 may be laminated on the first surface 311c of the first conductor layer 311. The second conductor layer 315 may cover the entire first surface 311c of the first conductor layer 311 or may cover a part of the first surface 311c of the first conductor layer 311. The portion of the first surface 311c of the first conductor layer 311, covered by the second conductor layer 315, may be 50% to 80% of the first surface 311c. The exposed area 313 of the first conductor layer 311 may be 20% to 50% of the first surface 311c.

As shown in FIG. 8 to FIG. 10, the second conductive layer 315 may be laminated on a region excluding the exposed area 313 in the first surface 311c of the first conductive layer 311, and an exposed area 316 exposed to the outside may be formed in the second conductive layer 315 in the region excluding the exposed area 313.

In the present embodiment, the second conductive layer 315 may have a thickness of about 30-40% of the thickness of the first conductive layer 311, and may be about ⅓ of the thickness of the first conductive layer 311, for example. Accordingly, when the second metal is heavier than the first metal, for example, when the first metal includes aluminum and the second metal includes copper, the weight of the busbar can be reduced while securing a minimum welding strength with respect to the electrode leads.

The second conductive layer 315 may extend from the first side edge 311a toward the second side edge 311b of the first conductive layer 311 while leaving the exposed area 313 of the first conductive layer 311. The second conductive layer 315 may extend from the first side edge 311a to the second side edge 311b.

The second conductive layer 315 may include a first portion 317, a second portion 318, and a third portion 319, and the first portion 317, the second portion 318, and the third portion 319 may be formed integrally.

The first portion 317 may be disposed parallel to the exposed area 313 of the first conductor layer 311, and the through hole 312 may be disposed between the first portion 317 and the exposed area 313. For example, the negative electrode lead 112 may be bonded to the first portion 317.

The second portion 318 may extend from one end of the first portion 317 toward the second side edge 311b. The second portion 318 may extend from one end of the first portion 317 to the second side edge 311b.

The third portion 319 may extend from the other end of the first portion 317 toward the second side edge 311b. The third portion 319 may extend from the other end of the first portion 317 to the second side edge 311b.

That is, the second portion 318 and the third portion 319 may extend parallel from both ends of the first portion 317. The exposed area 313 of the first conductor layer 311 may be disposed between the second portion 318 and the third portion 319.

The first portion 317, the second portion 318, and the third portion 319 may form the exposed area 316 in the second conductor layer 315.

In the present embodiment, the exposed area 313 where the first conductor layer 311 is exposed and the exposed area 316 where the second conductor layer 315 is exposed may be disposed together on one surface of the busbar 310, the positive electrode lead 111 may be bonded to the exposed area 313, and the negative electrode lead 112 may be bonded to the exposed area 316.

Accordingly, the positive electrode lead 111 made of aluminum may be bonded to the first conductor layer 311 made of the first metal, aluminum, and the negative electrode lead 112 made of copper may be bonded to the second conductor layer 315 made of the second metal, copper.

When an electrode lead made of a different metal from the busbar is bonded to the busbar, the crack occurrence rate may increase and weldability may decrease. In the present embodiment, as described above, the positive electrode lead 111 is bonded to the first conductive layer 311 of the same metal material, and the negative electrode lead 112 is bonded to the second conductive layer 315 of the same metal material, to achieve a homogeneous bond, thereby reducing the crack occurrence rate and improving the weldability.

In addition, a busbar weld plate 310a may be bonded to the second portion 318 of the second conductive layer 315 (refer to FIG. 13). The busbar weld plate 310a may be connected to a connector (not shown), and the connector to which the busbar weld plate 310a is connected may be connected to a connector 350 illustrated in FIG. 6. The connector 350 may be connected to a sensing part (sensing plate) (not shown) to perform functions such as sensing the voltage of the battery cell 110.

That is, the sensing part may be connected to the busbar 310 through the busbar weld plate 310a coupled to the busbar 310 to sense the voltage of the battery cell 110.

In the present embodiment, the busbar weld plate 310a may be made of the second metal (for example, copper). Therefore, the busbar weld plate 310a can be welded to the second conductor layer 315 made of the same second metal, and thus weldability can be improved.

The battery cells 110 constituting the battery cell stack 100 may be connected in series or in parallel by the busbars 310 and 320.

The busbars 310 and 320 may include a terminal busbar 320 for electrically connecting one battery module 100 to another battery module 100.

At least a part of the terminal busbar 320 may be exposed to the outside of the end plate 400 to be connected to another battery module 100, and the end plate 400 may include a terminal opening 410 for this purpose.

The terminal busbar 320 may have one end (second portion 322) exposed through an opening 510 of the insulating cover 500 and the terminal opening 410 of the end plate 400.

As illustrated in FIG. 4, the terminal busbar 320 may include a first portion 321 connected to the electrode leads 111 and 112 of the battery cell 110 and the second portion 322 exposed to the outside through the terminal opening 410. In addition, the terminal busbar 320 may further include a bent portion 323 formed between the first portion 321 and the second portion 322.

In the terminal busbar 320, the first portion 321 may be connected to the second portion 322 through the bent portion 323, and one side of the first portion 321 and one side of the second portion 322 may be perpendicular to each other. That is, by forming the bent portion 323 in the terminal busbar 320, the second portion 322 may protrude and be mounted on a mounting portion 530 of the insulating cover 500, and the second portion 322 may be electrically connected to a pack busbar (not shown). A joining hole 322a is formed in the second portion 322 constituting one end of the terminal busbar 320, and the second portion 322 of the terminal busbar 320 is fixed by a fixing pin (not shown) inserted into the joining hole 322a.

In the present embodiment, two terminal busbars 320 may be disposed on both sides of the busbar frame 300.

One of the two terminal busbars 320 may be a positive (+) terminal busbar 320, and the other may be a negative (−) terminal busbar 320.

In the present embodiment, the terminal busbar 320 on the left side in FIG. 6 may be the positive (+) terminal busbar 320 and may be made of aluminum (Al).

The electrode lead 111 made of the first metal may be bonded to the terminal busbar 320 on the left side made of the first metal (e.g., aluminum), and thus weldability can be improved by bonding the same type of metal.

In FIG. 4, the electrode lead 111 may be bonded to the first portion 321 of the terminal busbar 320 by welding. The terminal busbar 320 may be formed by nickel plating and tin plating.

In addition, a terminal busbar weld plate 320a may be bonded to the bent portion 323 of the terminal busbar 320 (refer to FIG. 13).

The terminal busbar weld plate 320a may be connected to a connector (not shown) like the busbar weld plate 310a, and the connector connected to the terminal busbar weld plate 320a may be connected to the connector 350 shown in FIG. 6. The connector 350 may be connected to a sensing part (sensing plate) (not shown) to perform functions such as sensing the voltage of the battery cell 110.

That is, the sensing part is connected to the terminal busbar 320 through the terminal busbar weld plate 320a coupled to the terminal busbar 320 and can sense the voltage of the battery cell 110.

In the present embodiment, the terminal busbar weld plate 320a may be made of the first metal (e.g., aluminum). Therefore, the terminal busbar weld plate 320a can be welded to the positive terminal busbar 320 made of the same first metal, and thus the weldability can be improved.

In FIG. 6, the terminal busbar 320 on the right may be a negative (+) terminal busbar 320 and may be made of copper (Cu).

The negative electrode lead 112 made of the second metal may be welded to the terminal busbar 320 on the right side made of the second metal (e.g., copper), and the weldability can be improved according to the same type of metal bonding.

In addition, a terminal busbar weld plate 320b may also be bonded to the terminal busbar 320 on the right side.

The terminal busbar weld plate 320b may be connected to a connector (not shown) like the busbar weld plate 310a, and the connector connected to the terminal busbar weld plate 320b may be connected to the connector 350 shown in FIG. 6. The connector 350 may be connected to a sensing part (sensing plate) (not shown) to perform functions such as sensing the voltage of the battery cell 110.

In the present embodiment, the terminal busbar weld plate 320b may be made of the second metal (for example, copper). Therefore, the terminal busbar weld plate 320b can be bonded to the negative terminal busbar 320 made of the same second metal, and thus the weldability can be improved.

The end plate 400 may be intended to protect the battery cell stack 100 and the electrical components connected thereto from external physical impact by covering the open surface of the module case 200. To this end, the end plate 400 may be manufactured from a material having a predetermined strength, and for example, the end plate 400 may include a metal such as aluminum or a plastic material.

The terminal opening 410 may be formed in the end plate 400. The terminal opening 410 may be disposed on each of both sides of the end plate 400, and a part of the insulating cover 500 and one end (the second portion 322) of the terminal busbar 320 may be exposed through the terminal openings 410.

In addition, a connector opening may be positioned between the terminal openings 410 disposed on both sides of the end plate 400, and the module connector may be exposed to the outside through the connector opening.

The end plate 400 may be combined with the module case 200 while covering the busbar frame 300 or the busbars 310 and 320 located on one side of the battery cell stack 100. Each corner of the end plate 400 may be combined with the corresponding corner of the module case 200 by welding, bolt fastening, hook fastening, or the like.

The end plate 400 may be positioned on one side and the other side of the module case 200 to cover both sides of the battery cell stack 100. In the present embodiment, an example in which the end plate 400 is positioned on the front and rear sides of the module case 200 is illustrated.

The insulating cover 500 may be disposed inside the end plate 400 and outside the busbar frame 300. In addition, the insulating cover 500 for electrical insulation may be positioned between the end plate 400 and the busbar frame 300. That is, the busbar frame 300, the insulating cover 500, and the end plate 400 may be sequentially positioned outside the battery cell stack 100. Like the end plate 400, a plurality of busbar frames 300 and a plurality of insulating covers 500 may be provided.

The insulating cover 500 may be made of an electrically insulating material or may include an insulating material and can block the busbars 310 and 320 from contacting the end plate 400.

The insulating cover 500 may include the opening 510 and a mounting portion 530. The opening 510 may be disposed on each of the upper sides of the insulating cover 500, and one end (the second portion 322) of the terminal busbar 320 can be exposed through the opening 510.

In addition, a connector opening may be positioned between the openings 510 disposed on both sides of the insulating cover 500, and the module connector may be exposed to the outside through the connector opening.

The insulating cover 500 may be located on the inner surface of the end plate 400, and may be in close contact with the inner surface of the end plate 400, but the present disclosure is not limited thereto.

As described above, one end (the second portion 322) of the terminal busbar 320 can be exposed through the opening 510, and the exposed one end (the second portion 322) of the terminal busbar 320 can be mounted on the mounting portion 530. Accordingly, the mounting portion 530 can be disposed to be adjacent to the opening 510 and can be positioned on the upper outer surface.

The second portion 322 of the terminal busbar 320 can be mounted on the upper surface of the mounting portion 530, and thus the upper surface of the mounting portion 530 can form a mounting surface. In addition, as illustrated in FIG. 5, the mounting portion 530 may include a fixing member 531 for fixing the terminal busbar 320.

The fixing member 531 may fix the second portion 322 of the terminal busbar 320 and may include a fixing hole 531a.

A fixing pin (not shown) can be inserted into the fixing hole 531a. The fixing pin (not shown) inserted into the joining hole 322a formed in the second portion 322 of the terminal busbar 320 is fixed by being coupled to the fixing hole 531a, and thus the second portion 322 of the terminal busbar 320 can be fixed to the insulating cover 500.

Therefore, the second portion 322 of the terminal busbar 320 is mounted on the mounting portion 530 of the insulating cover 500 and mounted on and comes into contact with the fixing member 531 disposed in the mounting portion 530.

In addition, a terminal cover (not shown) covering the exposed one end (the second portion 322) of the terminal busbar 320 may be disposed on the insulating cover 500.

Incidentally, electrical connection between battery modules 1000 may be made through a pack busbar (not shown). The pack busbar is a member for connecting one battery module 1000 to another adjacent battery module 1000 or a battery disconnection unit (BDU), and may be connected to the exposed one end (second portion 322) of the terminal busbar 320. For example, the pack busbar may be connected by overlapping one end (second portion 322) of the terminal busbar 320.

After one end of the pack busbar is disposed to overlapping the second portion 322 of the terminal busbar 320, the fixing pin is sequentially inserted into a joining hole of the pack busbar and the joining hole 322a of the second portion 322 of the terminal busbar 320, and then the fixing pin is fixed to the fixing hole 531a of the mounting portion 530, and thus the pack busbar can be connected to the terminal busbar 320.

In addition, the second portion 322 of the terminal busbar 320 may be fixed to the insulating cover 500 along with the pack busbar by the fixing pin.

One or more battery modules 1000 according to the present disclosure as described above can form a battery pack. The battery pack according to an embodiment of the present disclosure may accommodate at least one battery module 1000 inside a pack case, and may include various control and protection systems such as a battery management system (BMS) and a cooling system.

The battery module 1000 and the battery pack according to the present disclosure configured in this way can be applied to various devices. Specifically, they can be applied to means of transportation such as electric bicycles, electric vehicles, and hybrid vehicles, or an energy storage system (ESS), but are not limited thereto and can be applied to various devices that can use secondary batteries.

The present disclosure has been described with reference to preferred embodiments as described above, but is not limited to the above embodiments, and various changes and modifications may be made by those skilled in the art within the scope that does not depart from the spirit of the present disclosure.

### INDUSTRIAL APPLICABILITY

The present disclosure can provide a busbar and a battery module in which electrode leads and busbars made of the same metal are welded to improve weldability.

1. A busbar comprising:
a first conductive layer made of a first metal and having a first side edge, a second side edge opposite the first side edge, and a first surface extending between the first and second side edges; and
a second conductive layer made of a second metal, the second metal being different from the first metal, and laminated on and bonded to the first surface of the first conductive layer,
wherein the first conductive layer has an exposed area where the first metal is exposed on the first surface of the first conductive layer to which the second conductive layer is bonded, and the second conductive layer extends from the first side edge toward the second side edge of the first conductive layer, without covering the exposed area of the first conductive layer.

2. The busbar of claim 1, wherein the second conductive layer extends from the first side edge to the second side edge.

3. The busbar of claim 1, wherein the exposed area of the first conductive layer extends from the second side edge toward the first side edge.

4. The busbar of claim 1, wherein the first metal or the second metal includes aluminum.

5. The busbar of claim 1, wherein the first metal or the second metal includes copper.

6. The busbar of claim 1, wherein the first conductive layer has a through hole.

7. The busbar of claim 6, wherein the through hole is disposed between the exposed area and at least part of the second conductive layer.

8. The busbar of claim 1, wherein the second conductive layer comprises:
a first portion;
a second portion extending from a first end of the first portion toward the second side edge of the first conductive layer; and
a third portion extending from a second end of the first portion toward the second side edge of the first conductive layer.

9. The busbar of claim 8, wherein the first portion of the second conductive layer is arranged parallel to the exposed area of the first conductive layer.

10. The busbar of claim 8, wherein the first conductive layer has a through hole,
wherein the through hole is disposed between the first portion of the second conductive layer and the exposed area of the first conductive layer.

11. A battery module comprising:
a battery cell stack in which a plurality of battery cells is stacked;
a module case for accommodating the battery cell stack; and
one or more busbars for electrically connecting the battery cells,
wherein the busbar comprises:
a first conductive layer made of a first metal and having a first side edge, a second side edge opposite the first side edge, and a first surface extending between the first and second side edges; and
a second conductive layer made of a second metal, the second metal being different from the first metal, and laminated on and bonded to the first surface of the first conductive layer,
wherein the first conductive layer has an exposed area where the first metal is exposed on the first surface of the first conductive layer to which the second conductive layer is bonded, and the second conductive layer extends from the first side edge toward the second side edge of the first conductive layer, without covering the exposed area of the first conductive layer.

12. The battery module of claim 11, wherein an electrode lead of a battery cell of the plurality of battery cells made of the first metal is coupled to the exposed area of the first conductive layer, and an electrode leads of the battery cell of the plurality of battery cells made of the second metal is coupled to the second conductive layer.

13. The battery module of claim 11, wherein the second conductive layer extends from the first side edge to the second side edge.

14. The battery module of claim 11, wherein the exposed area of the first conductive layer extends from the second side edge toward the first side edge.

15. The battery module of claim 11, wherein the first metal or the second metal includes aluminum.

16. The battery module of claim 11, wherein the first metal or the second metal includes copper.

17. The battery module of claim 11, wherein the first conductive layer has a through hole.

18. The battery module of claim 11, further comprising a terminal busbar made of the first metal,
wherein an electrode lead of a battery cell of the plurality of battery cells made of the first metal is coupled to the terminal busbar.

19. The battery module of claim 11, further comprising a terminal busbar made of the second metal,
wherein an electrode lead of a battery cell of the plurality of battery cells made of the second metal is coupled to the terminal busbar.

20. The battery module of claim 11, further comprising a busbar frame disposed on one side of the battery cell stack,
wherein the busbar is disposed in the busbar frame.
